(19) United States
(12) Patent Application Publication
(10) Pub. No.: US 2015/0371173 A1
(43) Pub. Date: Dec. 24, 2015

(54) PEER TO PEER CHAT BASED COMMERCE SYSTEM

(71) Applicant: SENSAY, INC., VENICE, CA (US)

(72) Inventor: ARIEL JALALI, LOS ANGELES, CA (US)

(73) Assignee: SENSAY, INC., VENICE, CA (US)

(21) Appl. No.: 14/744,021

(22) Filed: Jun. 18, 2015

Related U.S. Application Data
(60) Provisional application No. 62/014,628, filed on Jun. 19, 2014.

(51) Int. Cl. G06Q 10/06; H04L 12/58; H04L 29/08

(52) U.S. Cl. CPC G06Q 10/063112; H04L 67/104; H04L 51/046

(57) ABSTRACT

A peer to peer chat based commerce system to buy and sell knowledge, digital and physical assets, exchanged by consumer-users and merchant-users via web-enabled devices transmitting through a communications gateway. The chat conversation is analyzed and parsed by a chat engine and salient information is stored on a database, where a matching engine and user engine work to match the consumer-user with a need for the knowledge to the merchant-user with an asset such as skills, expertise, knowledge or the like. The system the enables the consumer-user and merchant-user to exchange respective assets, such as payment in exchange for knowledge.

### CROSS-REFERENCE TO RELATED APPLICATIONS

This application claims priority from U.S. Provisional Patent Application No. 62/014,628, filed Jun. 19, 2014, which contents are hereby incorporated by reference in their entirety.

### BACKGROUND

The present invention is related to the technical field of web based and mobile software. More particularly, the present invention is directed to the technical field of peer to peer e-commerce, facilitated within a chat or instant messaging application.

Conventional e-commerce systems and applications provide live chat messaging capabilities only on the site and typically utilize employees of the site to chat with Consumers. These chats typically appear as an ancillary activity in a side window and do not provide for a Consumer to buy items inside the chat stream.

Conventional social media systems and applications, including social networking sites, blogs, forums and social answers sites and applications allow users to communicate with one another using text messages with rich media attachments. These social media systems typically monetize via an advertising based revenue model whereby users are provided free messaging and other services in exchange for viewing advertisements that are purchased and targeted by third party advertisers. Typically, average users of social media systems and applications do not have the ability to buy and sell digital and physical assets to one another via the chat messaging functionality.

Conventional instant messaging or chat systems and applications also allow users to communicate with one another using text messages with rich media attachments. These instant messaging or chat systems or applications typically monetize either by an advertising based revenue model or by selling the users premium features, subscriptions, services, games or digital assets. All commerce in these systems typically occurs between the service and the user. Typically, average users of instant messaging or chat systems and applications do not have the ability to buy and sell digital and physical assets to one another via the chat messaging functionality.

Conventional peer to peer marketplace systems and applications allow users to buy, sell, rent or share physical and digital assets with one another. Typically peer to peer marketplaces allow users to discover assets for purchase by searching or visually browsing for them. These assets are created as listings by Merchant users in advance of a Consumer user's visit to the site and his subsequent search or browse. The assets are typically provided on a one-to-many basis and not personalized by the Merchant for the Consumer.

There are currently little to no methods by which to address such advertising personally to individuals by name or like personal attribute.

### SUMMARY OF THE INVENTION

The present invention is directed to a peer to peer chat based commerce system to buy and sell knowledge, digital and physical assets. In one preferred embodiment, the peer to peer chat based commerce system for a consumer-user and a merchant-user to exchange skills for assets via respective web enabled devices, comprises a database memory storing data selected from a list of attributes consisting of users, chats, transactions messages, assets, personas, skills, and ratings; a processor including a matching engine, a user engine, and a chat engine each interfacing the database; a communication gateway including digital telecommunications means interfacing at least one of the matching engine, the user engine, and the chat engine; a consumer message containing at least one of a comment and rating, and a consumer asset, resident on the consumer-user device, interfacing via the communication gateway with the database; a merchant message containing at least one of a comment and rating, and a merchant skill, resident on the merchant-user device, interfacing via the communication gateway with the database; at least one of the matching engine, user engine, and chat engine analyzing the database and based on the list of attributes, matching a consumer-user to a merchant-user; and wherein the consumer-user delivers the consumer asset to the merchant-user, and the merchant-user delivers merchant skills to the consumer-user.

### BRIEF DESCRIPTION OF THE DRAWINGS

FIG. 1 is a preferred embodiment Database Model;

FIG. 2 is a preferred embodiment System Data Flow diagram;

FIG. 3 is a preferred embodiment Merchant Matching Data Flow diagram;

FIG. 4 is a preferred embodiment User Interface diagram for Digital Asset Sales; and

FIG. 5 is a preferred embodiment User Interface diagram for Information Transactions.

### DETAILED DESCRIPTION OF THE PREFERRED EMBODIMENTS

Glossary of Key Terms:

Account: User's financial data record on the system containing data on transactions, funding methods, payments and credits.

Application: Web or mobile software that affords system functionality to a user on a web, mobile or tablet device, by utilizing the Application Programming Interface (API).

Asset: Link to purchase or view metadata about a physical good, something corporeal (e.g., coins, cash, stock certificates, money order, etc.) or incorporeal (e.g., debit or credit card account, skills, knowledge, expertise, wisdom, etc.) having value, or purchase, utilize or download a digital object that can be inserted into a chat by a user.

Chat Engine: Communication component of the system, executed as a series of instructions in a microprocessor, server, chip, computer, and the like. Accepts a user's inputs via a chat interface and persists those inputs to the system for analysis and routing to other users, via the appropriate channels. Integrates with the communication gateway, matching engine, user engine and payment gateway.

Chat: Digital conversation between two or more users comprised of comments, assets and payments.

Channel: Communication mode including mobile or tablet application, web application, SMS text messaging or third party mobile or tablet applications.

Comment: The atomic unit of a chat. A chat is comprised of user comments which are inputted by either a Consumer, a Merchant or the system and delivered in messages by the Communication Gateway. The user inputs the Comment by using a keyboard or keyboard interface on a Web Enabled Device.

Communication Gateway: Messaging component of the system including all digital transceiver means, such as a cell tower, digital or optical transmission cables, routers, modems, communications servers, and the like. Accepts inputs from and sends data to a user's devices on various communication channels such as mobile or web application messaging, mobile push notification, email, social and SMS. The deliveries of the Communication Gateway are called Messages.

Consumer: User who is the buyer in a chat or the buyer of information or assets. The user who initiates the chat by composing a new need is the Consumer.

Deep Link: Hyperlink that links to a specific, generally searchable or indexed, piece of web content on a website or inside a web or mobile application.

Funding: Process by which a Consumer adds currency to his account via the Payment Gateway.

Import: Process by which a user can connect his external profiles on social or third party sites

Lead: Chat or chats purchased by keyword or need type, by a Merchant, in advance of a Consumer need. Pre-paid chats.

Matching Engine: User matching component of the system, executed as a series of instructions in a microprocessor, server, chip, computer, and the like. Accepts a Consumer's need, performs analysis and identifies relevant Merchants who can address that need.

Merchant: A user who is the seller in a chat or the provider of information or assets (e.g., expertise, wisdom, skills, knowledge, etc. in a subject area sought by a Consumer need).

Merchant Score: A Merchant's overall reputation score for all his transactions on the system.

Message: Delivery package of the Communication Gateway of data to and from users. Messages can contain comments, rating, assets and other objects.

Need: All the comments entered by a Consumer in a chat, starting from the first message he composes, representing the requirements he was attempting to address by initiating the chat.

Payment: Compensation provided by the system, on behalf of the Consumer, to the Merchant, for transactions in a chat.

Payment Gateway: Financial component of the system. Accepts currency from a Consumer via multiple payment sources and converts them into a virtual currency

Payment Source: Mode of funding a user's account including credit cards, online wallets, crypto currencies and other third party currencies.

Rating: Per chat reputation score received by each user in the chat, from the other user.

Skills: Areas of specific knowledge, wisdom, and/or expertise that a user has, represented as semantic terms or tags contained in chats a user has on the system, are reported by a user's friend about the user on the system or are imported from a third party system.

Tool: System applications configured by Merchants, using system interfaces, that allow the Merchant to perform certain functions or advanced functionality on the system.

Transaction: Sale between a Merchant and a Consumer, in a chat that involves a payment or lead decrement.

User Engine: User profile management component of the system, executed as a series of instructions in a microprocessor, server, chip, computer, and the like. Accepts user inputs in chats, profiles and imports and persists them to a user's system profile. Analyzes user skills. Stores and retrieves user assets.

Withdrawal: Merchant submits a request to the system to draw down his earnings in the form of currency, via the Payment Gateway.

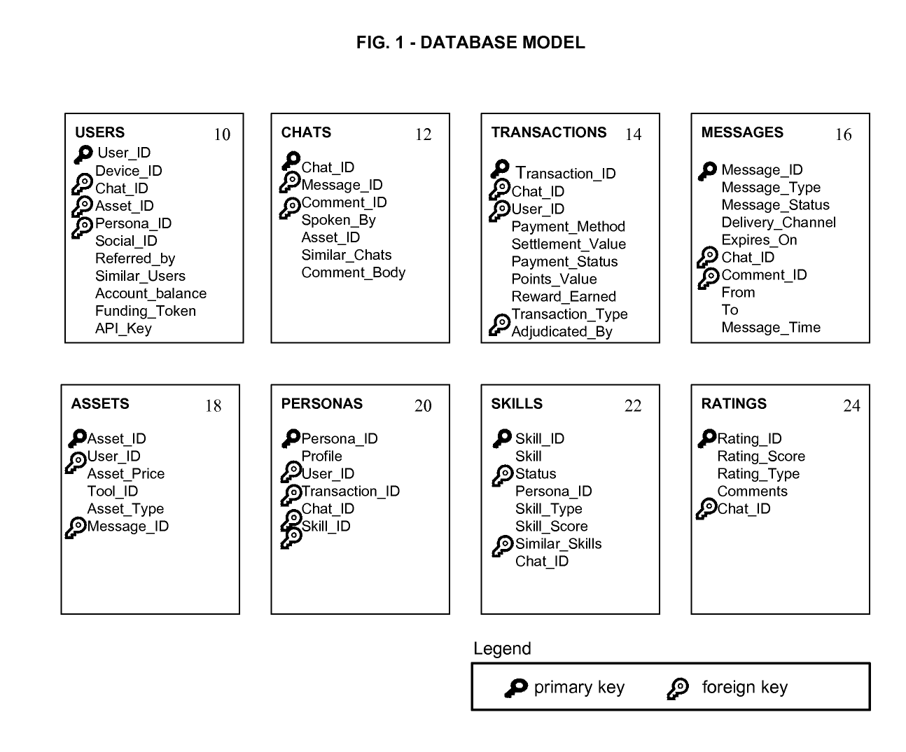

FIG. 1 depicts a preferred embodiment database model portion of the present invention system. Key tables in the database model are contained on a hard drive, optical drive, flash drive, tape drive, cloud drive, and the like, and include:

Users: Stores user contact, and identity data

Chats: Stores chats with associated comments and assets

Transactions: Stores user's financial transactions and payments

Messages: Stores messages and message status by delivery method

Assets: Stores digital assets provided by Merchants

Personas: Stores user data associated with a user's personas

Skills: Stores user skills and status of those skills

Ratings: Stores user ratings for all chats

The present invention system affords the user the following functionality, including:

Ability for a user to create an account.

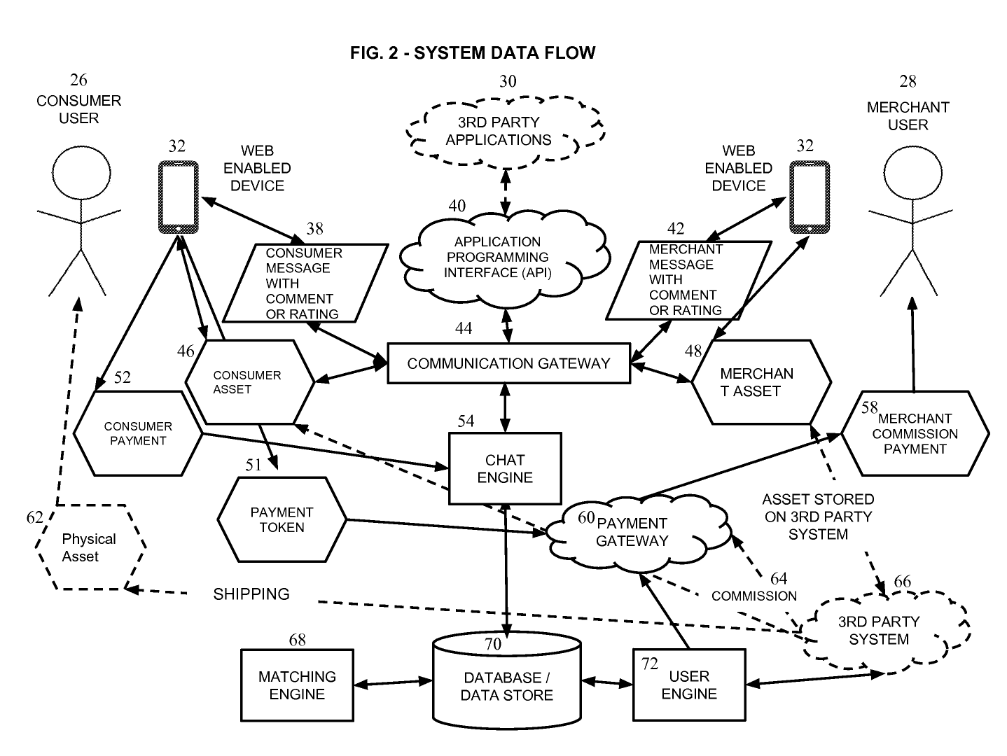

A user can create an account on the system (FIG. 2) in two ways, he or she can manually create an account or be referred by another user.

Users can have one or more personas. Referring to FIG. 1, a user, as represented by User_ID in the Users table 10, associates one or more Personas with his or her user account as represented by the Persona_ID in the Personas table 20. Each persona has an associated profile as represented by the Profile field in the Personas table 20. The databases of FIG. 1 are preferably resident on database/data store 70 such as a hard drive, flash drive, optical storage, cloud drive, tape drive, or like digital storage means, depicted in FIG. 2.

In FIG. 2, a web-enabled computer, mobile or tablet device 32 on which the user created the profile is assigned a Device_ID in the Users table 10 and is associated with his or her User_ID. A user may have multiple Device_IDs as he or she may access the system from multiple devices 32.

If the user was referred to the system by another user, the referring user is listed in the Referred_By field of the Users table 10.

Ability for a user to import skills to become a Merchant.

As a pre-condition, a user must have created an account on the system.

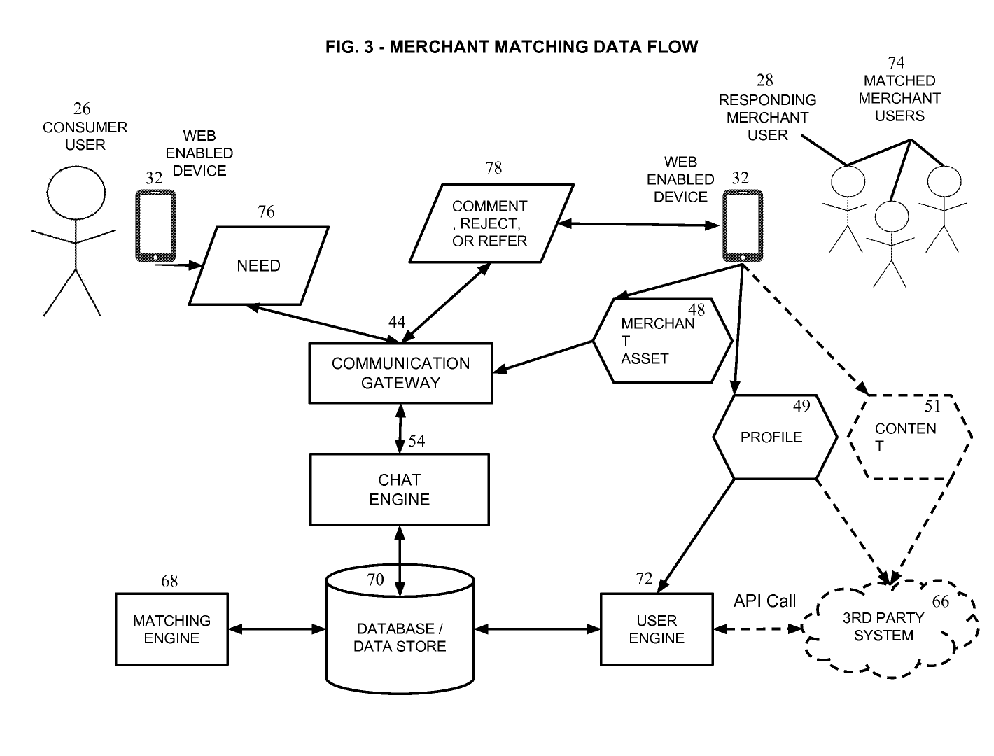

Referring to FIG. 3, there is shown a third party system 66 where a user has created and persisted a social profile, as a pre-condition. In further detail, referring to FIG. 1, a user on the system is able to input one or more social identifiers in his system profile, depicted in the Users table 10 as Social_ID1. Using Social_ID1, the User Engine 72 makes an API call to the third party system 66 and fetches the user's profile 49 from that external system (FIG. 3). It can make additional API calls to retrieve any published content 51 that the user has published on that third party system and notifies the User Engine 72 that it has retrieved new data.

The User Engine 72, as depicted in FIG. 3, parses and extracts skills from this externally published content and persists them to the Skill_ID and Skills field in Skills table 22, as shown in FIG. 1. In further detail, as shown in FIG. 1, the Skill_Score field is updated by the User Engine 72 that assigns higher scores for content for which the user got validation on the third party system from where they were imported.

The User Engine 72 may also perform quantitative analysis such as counting the relevant keywords and strings in the published content.

The User Engine 72 may further perform qualitative analysis such as counting the number of positive comments or indications that other users felt positively about the user's published content 51 or re-published the content multiple times, linked to or cited that content. It optionally utilizes third party tools and APIs to perform sentiment analysis on the metadata of the content such as determining whether comments from other users in reaction to the content are positive in nature.

The User Engine 72 also performs semantic analysis to assign when importing the skills, including doing a fuzzy match to find users who are similar to this user and updating the Similar_Users field in the Users table 10 and the Similar_Skills field in the Skills table 22 of the database/data store 70, depicted in FIG. 1. To perform this task, the User Engine 72 utilizes third party tools such as thesauri and ontologies of many subject areas.

These imported skills are now available for matching this Merchant 28 to a related Consumer 26 need. In further detail per FIG. 1, Skills imported from third party systems are assigned a Skill_Type in the Skills table 22 as “imported.”

Ability for a user to input skills to become a Merchant.

As a pre-condition, a user must have created an account on the system.

Referring to FIG. 1, a user, as represented by User_ID in the Users table 10, associates one or more Personas with his user account as represented by the Persona_ID in the Personas table 20. Each persona has an associated profile as represented by the Profile field in the Personas table.

Referring to FIG. 3, there is shown a user created profile 49. Using a web-enabled mobile or tablet device 32, the user inputs a free-form string of skills in an input box on his profile page. The user may also enter skills as comments in a chat with the system bot 102. The user can chat with the system bot in the same way that he chats with another user.

The User Engine 72, depicted in FIG. 3, parses and extracts skills from this user inputted profile 49 and persists them to the Skills table 22, as depicted in FIG. 1.

The User Engine 72 performs quantitative analysis such as counting the relevant keywords and strings in the inputted content.

The User Engine 72 also performs semantic analysis to assign when importing the skills, including doing a fuzzy match to find users who are similar to this user and updating the Similar_Users field in the Users table 10 depicted in FIG. 1. To perform this task, the User Engine utilizes third party tools such as thesauri and ontologies of many subject areas.

These inputted skills are now available for matching this Merchant to a related Consumer need. In further detail per FIG. 1, Skills inputted by the Merchant on his system profile are assigned a Skill_Type in the Skills table 22 as “inputted.”

Ability for a user to submit a need to become a Consumer.

As a pre-condition, a user must have created an account on the system.

Referring to FIG. 3, a user on a web-enabled computer, tablet or mobile device 32 composes a new need 76 by entering a comment into the interface. In further detail, referring to FIG. 3, the need 76 is sent via the Communication Gateway 44. Referring to FIG. 1, the comment is assigned a Message_ID in the Messages table 16, the Delivery_Channel is also notated in the Messages table 16, per channel the user utilized. Since the need 76 is the first comment in the chat, the Chat Engine 54 creates a new Chat_ID and assigns the user's User_ID as the Consumer in the Chats table 12 in the database/data store 70. Henceforth, in the context of this chat, the user is referred to as the Consumer 26.

In further detail, as depicted in FIG. 2, the Consumer's comments 38 in a chat are indexed in the database/data store 70 and per FIG. 1 the Consumer's comments are designated by the C_Comments

Ability for a Consumer to set a persona for a chat.

As a pre-condition, a user must have created an account on the system.

Referring to FIG. 3, when a Consumer 26 submits a need 76, he is able to set a persona for the chat. In further detail, as depicted in FIG. 1, the Consumer's Persona_ID is referenced for the new Chat_ID in the Personas table 20 in the database/data store 70. In further detail, as depicted in FIG. 1, the Consumer's Persona_ID is referenced in the Merchant field in the Chats table 12 in the database/data store 70.

Ability for the system to match a Consumer need to a list of matched Merchant users.

As a pre-condition, a Consumer 26 has submitted a need and at least one Merchant 28 user exists on the system.

Referring to FIG. 3, the need is passed via the Communication Gateway 44 to the Chat Engine 54 where it is parsed and analyzed for keywords. In further detail, referring to FIG. 1, the Skill_ID and Skills fields in the Chat table 22 is updated for the associated Chat_ID in the Skills Table 22 in the database/data store 70. Referring to FIG. 3, the Matching Engine 68 takes the skills in the Consumer's need, holds them in memory and attempts to find users who have skills in their profiles that match the skills in the Consumer's need. Referring to FIG. 1, a user's Skills are stored in the Skills table 22 in the database/data store 70. The Matching Engine 68 searches the Skill_ID, Skills and Similar_Skills fields of the Skills table 22, assembles a ranked list of Matched Merchant Users 74.

The list of Matched Merchant Users 74 is ranked by skill match, but the Matching Engine 68 also segments the list into tiers of users based on other metadata such as rating, responsiveness and match activity, in that preferred order of weighting. Referring to FIG. 1, rating is calculated by the average Rating_Score in the Ratings table 24 of the database/data store 70. Responsiveness is calculated by calculating the difference between the incoming and outgoing messages sent to and from a user in a chat using the Message_Time field in the Messages table 16 in the database/data store 70. Match activity is calculated by the total number of Needs 76 sent to a Matched Merchant User 74 in a given time period, for example one week. A quota of users with low recent match activity is allocated for each need to allow users who have not had a chance for activity on the system to receive matched needs, encouraging their further participation.

As represented by FIG. 3, the Matching Engine 68 supplies the users 26, in tiers, to the Communication Gateway 44. First tier users 26 are sent the Consumer's 26 Need 76. If no first tier users 26 reply to the Need 76 with a Comment/Reject/Refer message 78, then second tier users 26 are sent the Need 76 and so on down the list of the tiers until a Responding Merchant User 28 is identified.

Ability for the system to notify matched Merchant users of a Consumer's need as a pre-condition, the system has matched a Consumer's need with a list of matched Merchant users.

Referring to FIG. 3, the ranked list of potential users whose skills match the skills in the Consumer's Need 76 are called Matched Merchant Users 74. Referring to FIG. 1, Communication Gateway 44, via the Chat Engine 54, looks up the Device_ID in the Users table 10 for each of the Matched Merchant Users 74. The Communication Gateway 44 sends a message to each of the Matched Merchant Users 74 via his respective Web enabled device 32.

In FIG. 3, as an exception flow to the Merchant matching and messaging process, if the Matching Engine 68 fails to find users who have skills in their profiles that match the skills in the Consumer's Need 76, then the Matching Engine 68 generates an error message of, e.g., “sorry no matching users were found” which is transmitted in a message back to the Consumer 26 via the Chat Engine 54, though the Communication Gateway 44 to the Consumer 26.

Ability for a Merchant to reject a matched need.

As a pre-condition, the system has notified Matched Merchant Users 74 of a Consumer's Need 76.

Referring to FIG. 3, a Responding Merchant 28 replies to the Need 76, by replying with a Reject command 78 that is sent via the Communication Gateway 44 to the Chat Engine 54. By sending a Reject command 78, the Merchant indicates that he does not wish to chat with the Consumer 26. In FIG. 1, the Merchant's User_ID is not recorded in the Merchant field of the Chats 12 table in the database/data store 70.

Ability for one Merchant to refer another potential Merchant.

As a pre-condition, the system has notified Matched Merchant Users 74 of a Consumer's Need 76.

In FIG. 3, a Responding Merchant 28 replies to a need 76, by replying with a Refer command 78. The Responding Merchant 28 will input the contact information such as phone number, email address or social media username of the friend to whom he is referring need 76. In FIG. 1., when the referred friend accepts the Need 76, as forwarded to him by his friend, his account is created and given a User_ID and his phone number is recorded in the Device_ID field and email address or social media username are recorded in the Social_ID field Users table 10 in the database/data store 70. In FIG. 1, when the referred friend joins the chat, his User ID is recorded for the specific Chat_ID and all comments he enters in the chat are stored as M_Comments in the Chats table 12

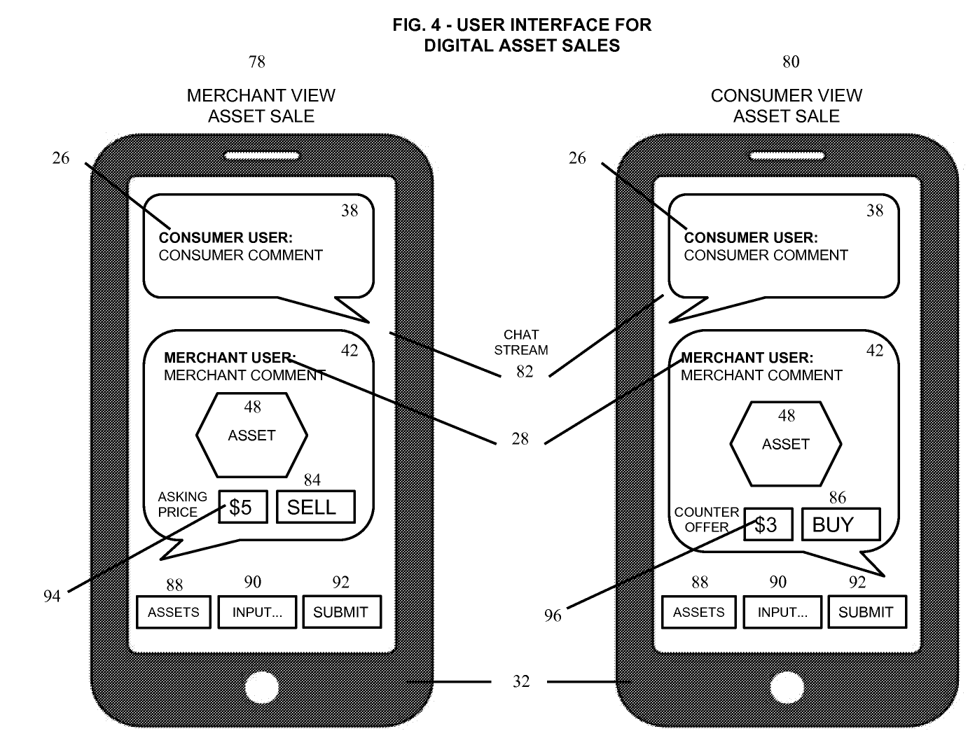

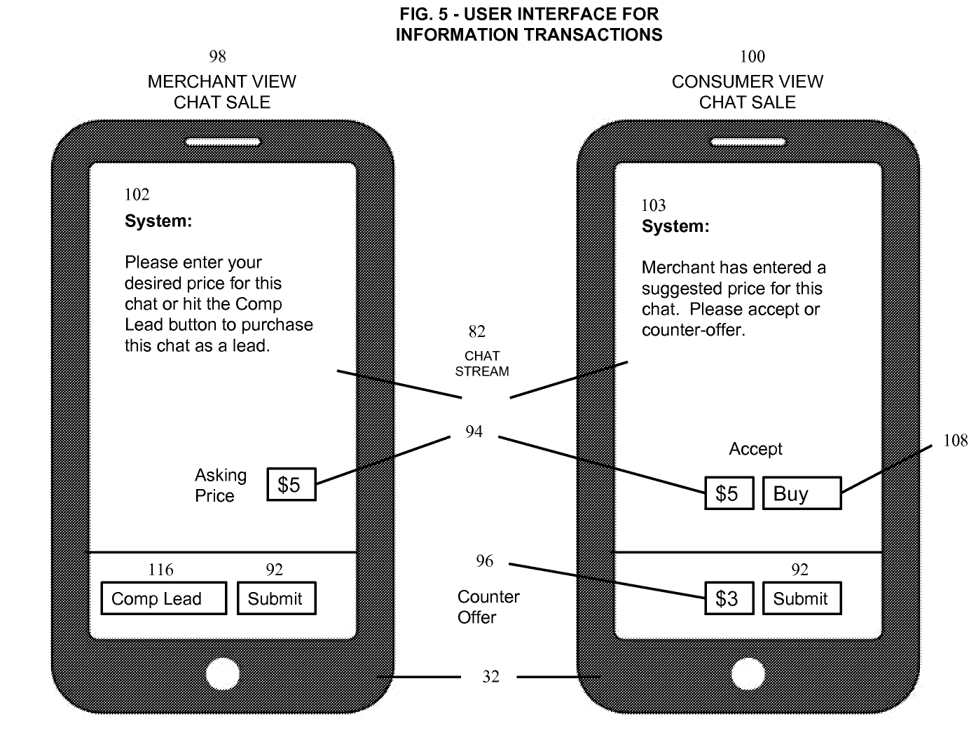

In FIG. 1, the referring Merchant User_ID is stored in the Referred_By field Transactions table 14 and is given credit for all transactions that take place in the chat after the referred friend joins the chat as Merchant. These transactions can be asset sales per FIG. 4 or information transaction sales per FIG. 5. Per FIGS. 1 and 2, the share of the Merchant_Commission 58 paid to the referring friend is based on the Settlement_Value of the chat in the Transactions table 14. The Transaction_Type field value for the payment to the referring friend is stored as “Referral_Payment.”

Ability for a Merchant to accept a matched need, set a persona and start chatting.

As a pre-condition, the system has notified matched Merchant users of a Consumer's need and a Merchant has accepted the matched Need.

In FIG. 3, a Responding Merchant 28 replies to a Need 76, by replying with a comment 78. The system prompts the Merchant to set a persona for the chat. As depicted in FIG. 1, the Consumer's Persona_ID is referenced for the new Chat_ID in the Personas table 20 in the database/data store 70. As depicted in FIG. 1, the Consumer's Persona_ID is referenced in the Merchant field in the Chats table 12 in the database/data store 70.

Ability for a user to submit comments in a chat.

As a pre-condition, a user must be a Merchant or a Consumer in a chat.

In FIG. 2, a Consumer User 26 submits a Consumer Message with Comment or Rating 38, via a Web Enabled Device 32 to the Communication Gateway 44, via the Chat Engine 54. A Merchant User 28 submits a Merchant Message with Comment or Rating 42, via a Web Enabled Device 32 to the Communication Gateway 44, via the Chat Engine 54.

In FIG. 4, users 26 input text comments into the Input box 90 and then hitting the Submit button 92. The Consumer Comment 32 and Merchant Comment 42 render or display in the Chat Stream on their respective Web Enabled Devices 32.

In FIG. 1, there is shown the Messages table 16 in the database/data store 70. Each user message is assigned a unique Message ID, the Message_Type is assigned an inbound or outbound value, the Message_Status field stores the delivery and read status of the message, the Delivery_Channel stores which Web Enabled Device 32 the user message was sent from or to, the Expires_On field stores the message's viewing or consumption expiration time set by system or user, the From field stores the sender's User_ID or assigns a value of “system” if from the system, the To field stores the recipient's User_ID or assigns a value of “system” if delivered to the system, the Message_Time field stores the date and time stamp of the message delivery or receipt and the Chat_ID field stores the chat to which the message belongs and relates to the Chat_ID in the Chats table 12. The Comment field in the Chats table 12 contains the actual inputted text string of the user's message.

Referring to FIG. 1, the Chats table 12 in the database/data store 70, for a given Chat_ID the user's submitted comments are attributed to him via association of his Persona_ID as related to his User_ID in the Spoken_By field.

Ability for a user to submit assets in a chat.

As a pre-condition, a user must be a Merchant or a Consumer in a chat.

Referring to FIG. 2, a Consumer 26 may insert a Consumer Asset 46 into the chat stream. A Merchant 28 may also insert a Merchant Asset 48 into the chat stream. Referring to FIG. 4, the user interface affords the user to tap the Assets button 88 which will provide the user access to assets on the file system of his Web Enabled Device 32 or stored on a 3rd Party System 66. The user submits assets into the Chat Stream 82 via the Submit button 92. In FIG. 2, assets are sent to the Communication Gateway 44, via the Chat Engine 54.

The asset may be consumable or playable in the user interface directly or link the user out via a URL to consume or play the asset on a 3rd Party System or other application on the user's Web Enabled Device 32, via a deep link.

Referring to FIG. 1, the Assets table 16 in the database/data store 70, the submitted asset is assigned an Asset_ID and is related to the specific Chat_ID in the Chats table 12. The user who submits the asset's User_ID is recorded. The Asset_Type field value records the type of asset that was submitted, for example, media type video, media type audio, media type application, or the like. The Message_ID field stores the identifier of the message that contained the asset and delivered it to the Communication Gateway 44. If it was a Merchant Asset 48, then the Merchant's 28 suggested or desired price for the asset is stored in the Asset_Price field. Although the Merchant 28 set's the asset price at time of insertion, the Asset_Price field can be updated by the Merchant 28 at any time prior to, during or post chat.

Ability for the system to index skills from chats.

As a pre-condition, a user must be a Merchant 28 in a chat.

Referring to FIG. 2, each Merchant Message 42 is sent on the user's Web Enabled Device 32 via the Communication Gateway 44, to the Chat Engine 54 and stored in the Database/Data store 70.

In FIG. 1, the Chats table 12 in the database/data store 70, for the specific Chat_ID, the Merchant field stores the User_ID of the Merchant 28 in the chat. The M_Comments field stores the Comment_ID for each comment submitted by the Merchant 28

The User Engine 72, depicted in FIG. 3, parses and extracts skills from the chat and persists them to the Skills table 22, as shown in FIG. 1. Each skill in the Chat_ID is assigned a Skill_ID. The Skill field stores the actual keyword or phrase in the comment. The Status field stores whether the skills were in a comment that was read or responded to by the Consumer. The Persona_ID of the Merchant in the chat is recorded. The Skill_Type field stores the topical classification of the skill area using third party tools such as thesauri and ontologies.

The User Engine 72 performs quantitative analysis such as counting the relevant keywords and strings in the Merchant's 28 comments. The Skill_Score field records how contextually relevant the skill was to the overall chat.

The User Engine 72 also performs semantic analysis to assign when indexing the skills, including doing a fuzzy match to find users who are similar to this user and updating the Similar_Users field in the Users table 10, chats which are similar updating the Similar_Chats field in the Chats table 12 and skills which are similar by updating the Similar_Skills in the Skills table 22. To perform this task, the User Engine utilizes third party tools such as thesauri and ontologies of many subject areas.

These indexed skills are now available for matching this Merchant to a related Consumer need. In further detail per FIG. 1, skills inputted by the Merchant on his system profile are assigned a Skill_Type in the Skills table 22 as “verified_in_chat” to indicate the skills were indexed in a chat.

Ability for a user to fund an account.

As a pre-condition, a user must have an account on the system.

Referring to FIG. 2, a user submits his financial credentials via a Payment Token 51 to the Payment Gateway 60. The Payment Token 51 allows the Payment Gateway 60 to conduct financial transactions on behalf of the user on a 3rd Party System 66. When a user wants to add financial funds to his account he makes a Consumer Payment 52 of a specified monetary value via his Web Enabled Device 32.

Referring to FIG. 1, the User table 10 in the database/data store 70, for a specific User_ID, the Funding_token field stores the Payment Token 51. The Transactions table 14 in the database/data store 70, when a user adds funds to his account the Transaction_Type field records the value as “funded” and the Settlement_Value field stores the monetary value of the funding transaction.

Ability for a user to make a withdrawal from an account.

As a pre-condition, a user must have an account on the system and have earned some payments as a Merchant.

Referring to FIG. 2, a user submits his financial credentials via a Payment Token 51 to the Payment Gateway 60. The Payment Token 51 allows the Payment Gateway 60 to conduct financial transactions on behalf of the user on a third Party System 66. When a user wants to withdraw financial funds from his account he submits a request for a Consumer Payment 52 of a specified monetary value via his Web Enabled Device 32.

In FIG. 1, the User table 10 in the database/data store 70, for a specific User_ID, the Funding_token field stores the Payment Token 51. The Transactions table 14 in the database/data store 70, when a user withdraws funds from his account, the Transaction_Type field records the value as “withdrawn” and the Settlement_Value field stores the monetary value of the withdrawal transaction.

Ability for a Consumer to purchase an asset.

As a pre-condition, a user must have an account on the system and be in a chat with a Merchant 28, as a Consumer 26.

In FIG. 2, there is shown a Merchant Asset 48 submitted in a chat via the Communication Gateway 44 to the Chat Engine 54. The Consumer 26 makes a Consumer Payment 52 for the asset by submitting a Payment Token 51 to the Payment Gateway 60.

In FIG. 4, there is shown the Merchant View Asset Sale 78 and the Consumer View Asset Sale 80. The Merchant inserts the Merchant Asset 48 into the Chat Stream 82 within the Merchant Comment 42, by tapping the Asset 48 button, selecting the asset 48 from his Web Enabled Device 32 or third Party System 66. The Merchant 28 specifies a desired Asking Price 94 and taps the Submit button 92 to confirm asset insertion in to chat. The Consumer 26 responds by tapping the Buy button 86 or entering a Counter Offer 96 via The Consumer Comment 38. If there is a Counter Offer 96 submitted, the Merchant 28 can accept the Counter Offer 96 by tapping the Sell button 84.

In FIG. 1, the Chats table 12 in the database/data store 70 for a specific Chat_ID, the Consumer field stores the Persona_ID associated with the User_ID of the Consumer and the Merchant field stores the Persona_ID associated with the User_ID of the Merchant. Still in FIG. 1, the Assets table 18 in the database/data store 70 the Asset_ID is retrieved along with the Asset_Price and the associated metadata from the Asset_Type field. The User_ID of the Merchant 28 who provided the asset is also retrieved.

In FIG. 1, the Transactions table 14 in the database/data store 70 a Transaction_ID is created for the asset sale associated with the Chat_ID. The Payment_Method field records the method of payment specified on the consumer account. The Settlement_Value stores the final price of the sale. The Payment_Status field is updated at each stage in the transaction from “new” to “counter_offered” to “settled.” The Transaction_Type field is updated with the value of “asset_sale.” The optional Points_Value field is updated with additional virtual rewards that he gains on the system that do not have a monetary value via the Reward_Earned field.

Ability for a Consumer to purchase a chat.

As a pre-condition, a user must have an account on the system and a Merchant 28 and Consumer 26 must be in a chat.

Referring to FIG. 5, there is shown the Merchant View Chat Sale 98 and Consumer View Chat Sale 100. A Consumer 26 can purchase a chat during an open chat or at the end of the chat when either the Consumer 26 or the Merchant 28 closes the chat.

If the Consumer decides to purchase the chat during an active chat, the Consumer 26 can agree to the Asking Price 94 for the chat, if there is one set by the Merchant or the Consumer can send a Counter Offer 96 and the Consumer 26 hits the Buy button 108.

A System Message to the Merchant 102 is sent to the Merchant 28 letting the Merchant 28 know the Consumer has accepted the Asking Price 94 or the Consumer 26 has made a Counter offer 96.

In FIG. 2, the Consumer 26 makes a Consumer Payment 52 for the asset by submitting a Payment Token 51 to the Payment Gateway 60, via the Communication Gateway 44 to the Chat Engine 54.

In FIG. 1, the Chats table 12 in the database/data store 70 for a specific Chat_ID, the Consumer field stores the Persona_ID associated with the User_ID of the Consumer and the Merchant field stores the the Persona_ID associated with the User_ID of the Merchant. The Transactions table 14 in the database/data store 70 a Transaction_ID is created for the chat sale associated with the Chat_ID. The Payment_Method field records the method of payment specified on the consumer account. The Settlement_Value stores the final price of the sale. The Payment_Status field is updated at each stage in the transaction from “new” to “counter_offered” to “settled.” The Transaction_Type field is updated with the value of “chat_sale.” The optional Points_Value field is updated with additional virtual rewards that he gains on the system that do not have a monetary value, via the Reward_Earned field.

Ability for a Merchant to purchase a lead.

As a pre-condition, a chat between a Merchant 28 and a Consumer 26 must exist and a Consumer 26 has submitted his final price for the chat.

Referring to FIG. 5, there the Merchant View Chat Sale 98. The Merchant 28 is shown a System Message to the Merchant 102 asking him if he wants to provide this chat to the Consumer 26 for free and purchase the chat as a lead instead. If the Merchant 28 agrees to purchase the lead, he presses the Comp Lead Button 116, then the Consumer is shown a System Message to the Consumer 103 telling him that the Merchant 28 has paid for his chat and there will be no charge to the Consumer's 26 account. The chat price is deducted from the Merchant's 28 account.

In FIG. 1, the Chats table 12 in the database/data store 70 for a specific Chat_ID, the Consumer field stores the Persona_ID associated with the User_ID of the Consumer and the Merchant field stores the the Persona_ID associated with the User_ID of the Merchant.

In FIG. 1, the Transactions table 14 in the database/data store 70 a Transaction_ID is created for the chat sale associated with the Chat_ID. The Payment_Method field records the method of payment specified on the consumer account. The Settlement_Value stores the final price of the sale. The Payment_Status field is updated at each stage in the transaction from “new” to “counter_offered” to “settled.” The Transaction_Type field is updated with the value of “lead_sale.” The optional Points_Value field is updated with additional virtual rewards that he gains on the system that do not have a monetary value, via the Reward_Earned field.

Ability to submit a rating as a Merchant or a Consumer.

As a pre-condition, a chat must be closed. The Merchant 28 and the Consumer 28 are given the opportunity to rate one another.

In FIG. 2, the Consumer 26 submits a Consumer Message With Comment or Rating 38 and the Merchant 28 submits a Merchant Message With Comment or Rating 42, via the Communication Gateway 44 to the Chat Engine 54. The User Engine 52 looks up the User_ID by associated Persona_ID of the Merchant 26 and the Consumer 28 in a specific Chat_ID. The User Engine 54 records the rating each party in the chat receives from the other party.

In FIG. 1, the Rating table 24 in the database/data store 70 both the Consumer 26 rating of the Merchant 28 and the Merchant 28 rating of the Consumer 26 are assigned a Rating_ID for a specific Chat_ID. The Rating_Score is submitted by each user for the rating and is a numeric value, for example 9 out of a possible 10 scale score. The Rating_Type field stores a value of “merchant_rating” or “consumer_rating.” The Comments field stores qualitative descriptive comments submitted but each party about the rating.

Ability for a Merchant to help adjudicate a dispute between another Merchant and Consumer.

As a pre-condition, a user must have completed a chat and the Consumer 26 in the chat disputes a transaction based on satisfaction with his interaction with the Merchant 28 in the chat.

In FIG. 5, the system sends a System Message to Merchant 103 informing him that there is a chat where he is needed to help adjudicate a transaction dispute. The adjudicating Merchant 28 is selected based on matching skills and availability. If the adjudicating Merchant 28 responds to the message, he is shown the Chat Stream 82 of the entire chat in dispute and makes a ruling via Input box 90 and Submit button 92. If the adjudicating Merchant 28 rules in favor of the Consumer 26 then the User Engine 54 processes the refund via the Payment Gateway 60.

In FIG. 1, the Transactions table 14 in the database/data store 70 the User_ID of the adjudicating Merchant 28 is stored in the Adjudicated_By field for the specific Transaction_ID associated with the Chat_ID. If the adjudicating Merchant 28 rules in favor of the Consumer 26, then the Settlement_Value amount is refunded to the Consumer's 26 account by the Payment_Method the Consumer has configured on his account. The Payment_Status field is updated to “refunded.” The Transaction_Type is set to “adjudicated_refund.”

The optional Points_Value field is updated with additional virtual rewards that the adjudicating Merchant 28 gains on the system that do not have a monetary value, via the Reward_Earned field.

Ability for a developer to use system application programming interfaces (APIs).

As a pre-condition, a user must have an account on the system.

In FIG. 1, the Users table 10 in the database/data store 70, for a particular User_ID, the system generates a unique API_Key that the user can utilize as an authentication token for access to the Application Programming Interface (API) 40. In FIG. 2, users can develop 3rd Party

Applications 30 via the API 40 that have a full set of system functionality. Developer users can configure their own interfaces for these 3rd Party Applications 30.

Ability for a Merchant to use system tools to enhance his productivity.

As a pre-condition, a user must have an account on the system and be a Merchant 28 and also have an API_Key giving him the ability to be a 3rd party developer. As an additional pre-condition, a user has developed a 3rd Party Application 30 using the API 40.

A Merchant 28 in a chat can use 3rd Party Applications 30 developed by other users to help him in the course of a chat. For example, there may be a chat bot application that helps a Merchant 28 auto respond to certain messages from a Consumer 26. This chat bot application was developed by another Merchant user 28. The developer Merchant 28 sets the Asset_Price

In FIG. 1, the Assets table 18 in the database/data store 70 for a specific Asset_ID, the User_ID of the developer Merchant 28 and Asset_Price are stored. The Asset_Type is set to “merchant_tool” and a Tool_ID is assigned. The Transactions table 14 in the database/data store 70, when a Merchant 28 uses the 3rd Party Application 30 that has an Asset_Type of “merchant_tool” he is charged the Asset_Price for the tool usage on a flat fee or per usage basis.

The Transactions table 14 in the database/data store 70 the User_ID of the Merchant 28 who uses the 3rd Party Application 30 is stored for the specific Transaction_ID associated with the Chat_ID. Based on tool usage, the Settlement_Value is charged to the Merchant's 28 account by the Payment_Method the Merchant has configured on his account. The Payment_Status field is updated to “refunded.” The Transaction_Type is set to “merchant_tool_used.”

The optional Points_Value field is updated with additional virtual rewards that the developer Merchant 28 or tool using Merchant 28 gains on the system that do not have a monetary value, via the Reward_Earned field.

Alternative embodiments include the following:

User can access chat related functionality using command line input method instead of interface elements in applications.

All functionality and interfaces described can also be accessed via the API.

Text based chat described here may also be a video chat with camera and microphone enabled for both Consumer and Merchant 28 or a telephone or voice based chat with a microphone enabled for both a Consumer and a Merchant 28. For phone based chat, the system would support telephony interfaces by users could enter commands using touch tone dialing in addition to or as a substitute to functionality provided by mobile phones.

One to one chat described here can be extended to a one to many or a many to many group chat where there are multiple Merchants 28 or Consumers 26 participating in a chat simultaneously and earnings are divided amongst the participating Merchants 28.

FIG. 5 depicts a Consumer paying for an entire chat in a single information transaction. However, the system supports multiple information transactions in a single chat. A Consumer may pay a Merchant 28 for incremental value provided after one or more comments in the chat.

Users on a web enabled computer, mobile or tablet device may access the system via native device applications, a web browser or SMS.

Financial transactions are described here as micro-transactions whereby a user spends actual currency (e.g. US Dollars) when he buys something. However, the system can also support a credit based approach where the user funds his account in actual currency (e.g. US Dollars or international currency) or crypto-currency (e.g. Bitcoin) and receives credits which he can then spend to buy things. The present invention system can also support micro-transactions in crypto-currency (e.g. Bitcoin.)

The process of a Merchant 28 purchasing a lead has been described as ad-hoc on a per chat basis. However the present invention system will also support the ability for the Merchant 28 to receive volume pricing discounts when purchasing a number of leads up front or receiving volume pricing discounts upon reaching a certain number of leads purchased.

Metadata for segmenting the Matched Merchant Users 74 is not an exhaustive list. One can assume other metadata will be available for analysis, based on user behavior and actions on the system over time and also metadata imported from third party systems.

Buttons depicted on interface diagrams may contain different labels and may vary in type, size, appearance, operation, and placement.

Numeric values including chat prices and rating scales and monetary values are described for the purposes of depicting the invention and are not literal. The present invention system can support a variety of numeric values, rating scales and monetary values.

Assets inserted into the Chat Stream 82 may include but are not limited to documents, lists, images, audio files, video files, location pins, calendar events, surveys, deep links to media assets, physical or virtual goods available in other web or mobile applications, deep links to other downloadable mobile applications or web applications.

Assets inserted into the Chat Stream 82 may simply have a buy price set by the Merchant 28 and the interface may not offer the Consumer 26 the ability to counter offer.

Although only the indexing of the Merchant's 28 comments for assignment of skills is described, the User Engine 72 may also analyze the relationship between the Consumer's 26 comments in response to the Merchant's 28 comments and vice versa to establish a quality score of the relationship between the comments submitted but the Merchant and Consumer, seeing them as comment groups rather than each comment as an individual atomic unit. Factors such as response velocity and relevance of comment group to the main topic of the chat may be analyzed.

Although user rating of the entire chat is described, the present invention system and interface may afford users the ability to rate individual comments that they like over others in a chat. Comments specific ratings could impact the boosting of Merchant 28 skills in the chat

Database field values described are not an exhaustive list and the system can support additional field values, based on configurable business logic

Various modifications may be made to the present invention without departing from the scope thereof. Although individual features of embodiments of the present invention may be shown or described in some of the drawings or discussions, respectively, and not in others, those skilled in the art will recognize that individual features of one embodiment of the invention can be combined with any or all of the features of another embodiment.

I claim:

1. A peer to peer chat based commerce system for a consumer-user and a merchant-user to exchange skills for assets via respective web enabled devices, comprising:
a database memory storing data selected from a list of attributes consisting of users, chats, transactions messages, assets, personas, skills, and ratings;
a processor including a matching engine, a user engine, and a chat engine each interfacing the database;
a communication gateway including digital telecommunications means interfacing at least one of the matching engine, the user engine, and the chat engine;
a consumer message containing at least one of a comment and rating, and a consumer asset, resident on the consumer-user device, interfacing via the communication gateway with the database;
a merchant message containing at least one of a comment and rating, and a merchant skill, resident on the merchant-user device, interfacing via the communication gateway with the database;
at least one of the matching engine, user engine, and chat engine analyzing the database and based on the list of attributes, matching a consumer-user to a merchant-user; and
wherein the consumer-user delivers the consumer asset to the merchant-user, and the merchant-user delivers merchant skills to the consumer-user.

2. The peer to peer chat based commerce system of claim 1, wherein a third party system resident on a digital device discrete from the system, interfaces with the user engine for conducting financial transactions to digitally transfer assets between the consumer-user and the merchant-user.

3. The peer to peer chat based commerce system of claim 1, wherein a third party application resident on a digital device discrete from the system, interfaces with the communication gateway to access the chat engine.

4. The peer to peer chat based commerce system of claim 1, wherein the consumer-user via the web enabled device generates a need and the merchant-user via the web enabled device generates a skill, the devices interfacing with the communications gateway to the chat engine.

5. A computer implemented method for a peer to peer chat based commerce system for a consumer-user and a merchant-user to exchange skills for assets via respective web enabled devices, comprising:
providing a database memory storing data selected from a list of attributes consisting of users, chats, transactions messages, assets, personas, skills, and ratings;
providing a processor including a matching engine, a user engine, and a chat engine each interfacing the database;
providing a communication gateway including digital telecommunications means interfacing at least one of the matching engine, the user engine, and the chat engine;
providing a consumer message containing at least one of a comment and rating, and a consumer asset, resident on the consumer-user device, interfacing via the communication gateway with the database;
providing a merchant message containing at least one of a comment and rating, and a merchant skill, resident on the merchant-user device, interfacing via the communication gateway with the database;
processing via at least one of the matching engine, user engine, and chat engine to analyze the database based on the list of attributes, matching a consumer-user to a merchant-user;
delivering the consumer asset to the merchant-user from the consumer-user; and
delivering merchant skills to the consumer-user from the merchant-user.
